(19) United States
(12) Patent Application Publication
(10) Pub. No.: US 2019/0154548 A1
(43) Pub. Date: May 23, 2019

(54) MACHINE DIAGNOSTIC METHOD AND DIAGNOSTIC SYSTEM THEREOF

(71) Applicant: INSTITUTE FOR INFORMATION INDUSTRY, Taipei City (TW)

(72) Inventors: Ci-Yi LAI, Taichung City (TW); Hung-An KAO, Taipei City (TW); Hung-Sheng CHIU, Taichung City (TW)

(73) Assignee: INSTITUTE FOR INFORMATION INDUSTRY, Taipei City (TW)

(21) Appl. No.: 15/834,885

(22) Filed: Dec. 7, 2017

(30) Foreign Application Priority Data
Nov. 20, 2017 (TW) 106140025

(51) Int. Cl. G01M 99/00; G05B 23/02

(52) U.S. Cl. CPC G01M 99/008; G01M 13/028; G05B 23/0289; G05B 23/0283

(57) ABSTRACT

A machine diagnostic system includes a performance evaluating module, a machine adjusting module and multiple sensors. The performance evaluating module evaluates the performance value of a part of a machine prior to production and predicts whether the part can be used to complete multiple batches of semi-products. If yes, the machine adjusting module sets a set value of the machine so that the machine can complete the multiple batches of semi-products. When the batches of semi-products are processed by the machine, a real-time production data is generated. When the sensors detect that the real-time production data contains an abnormal state data, re-evaluating whether the machine can complete the remaining semi-products according to the set value. If yes, enabling the machine to continue processing the remaining semi-products according to the set value. If no, updating the set value of the machine.

This application claims the benefit of Taiwan application Serial No. 106140025, filed Nov. 20, 2017, the subject matter of which is incorporated herein by reference.

### BACKGROUND

### Technical Field

The invention relates in general to a diagnostic method, and more particularly to a machine diagnostic method capable of pre-diagnosing the performance of a part of a machine and adjusting a set value of the machine, and a machine diagnostic system thereof.

### Description of the Related Art

The performance of a part of a machine may deteriorate over a long period of use. When the part has an abnormal state, the machine must stop and the operator must call the repair technician to check or arrange a repair schedule. If the part can no longer be used, the operator can only wait for the replacement or maintenance of the part. Under such circumstance, it is hard to be adjusted. Particularly, when the part is abnormal and makes the machine unable to complete a batch of semi-products, the remaining semi-products may be discarded as worthless or may need to be processed again. It is not only increasing the manufacturing cost but also decreasing the production efficiency.

### SUMMARY

The invention is directed to a machine diagnostic method and a system thereof capable of evaluating the performance of a part of a machine and timely adjusting a set value of the machine according to a real-time production data to be adapted to the actual production state of the machine.

According to one embodiment of the invention, a machine diagnostic method is provided. The machine diagnostic method includes following steps: evaluating, by a processor, a performance value of a part of a machine prior to production; predicting, by the processor, whether the part can be used to complete a plurality of batches of semi-products; in response to predicting that the part can be used to complete the plurality of batches of semi-products, setting, by the processor, a set value of the machine to enable the machine to complete the plurality of batches of semi-products; enabling, by the processor, the machine to process the plurality of batches of semi-products to generate a real-time production data; in response to detecting that the real-time production data contains an abnormal state data, re-evaluating, by the processor, whether the set value of the machine enables the machine to complete remaining batches of semi-products; in response to re-evaluating that the set value of the machine enables the machine to complete the remaining batches of semi-products, enabling, by the processor, the machine to continue processing the remaining batches of semi-products according to the set value; in response to re-evaluating that the set value of the machine does not enable the machine to complete the remaining batches of semi-products, updating, by the processor, the set value of the machine to enable the machine to complete the remaining batches of semi-products.

According to another embodiment of the invention, a machine diagnostic system including a processor and a plurality of sensors is provided. The processor includes a performance evaluating module and a machine adjusting module. The performance evaluating module evaluates the performance value of a part of a machine prior to production and predicts whether the part can be used to complete multiple batches of semi-products. In response to predicting that the part can be used to complete the plurality of batches of semi-products, the machine adjusting module sets a set value of the machine to enable the machine to complete the plurality batches of semi-products. The plurality of sensors senses the machine processing the plurality of batches of semi-products to generate a real-time production data. In response to detecting that the real-time production data contains an abnormal state data, the performance evaluating module re-evaluates whether the set value of the machine enables the machine to complete remaining batches of semi-products. In response to re-evaluating that the set value of the machine enables the machine to complete the remaining batches of semi-products, the machine adjusting module enables the machine to continue processing the remaining batches of semi-products according to the set value. In response to re-evaluating that the set value of the machine does not enable the machine to complete the remaining batches of semi-products, the machine adjusting module updates the set value of the machine to complete the remaining batches of semi-products.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a schematic diagram of a machine diagnostic system according to an embodiment of the invention.

FIG. 2 is a schematic diagram of a machine diagnostic method according to an embodiment of the invention.

### DETAILED DESCRIPTION

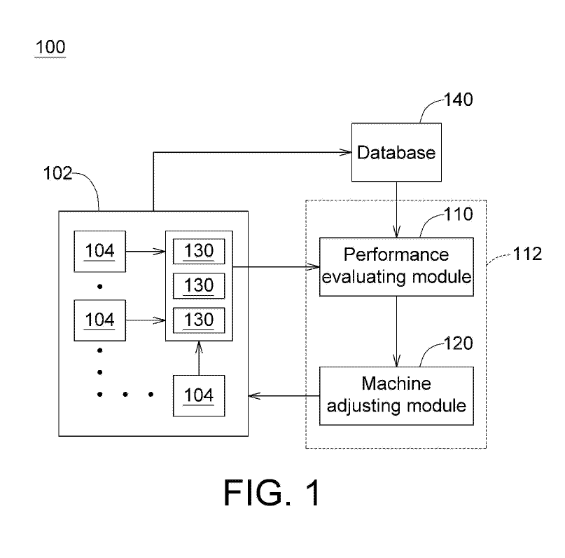

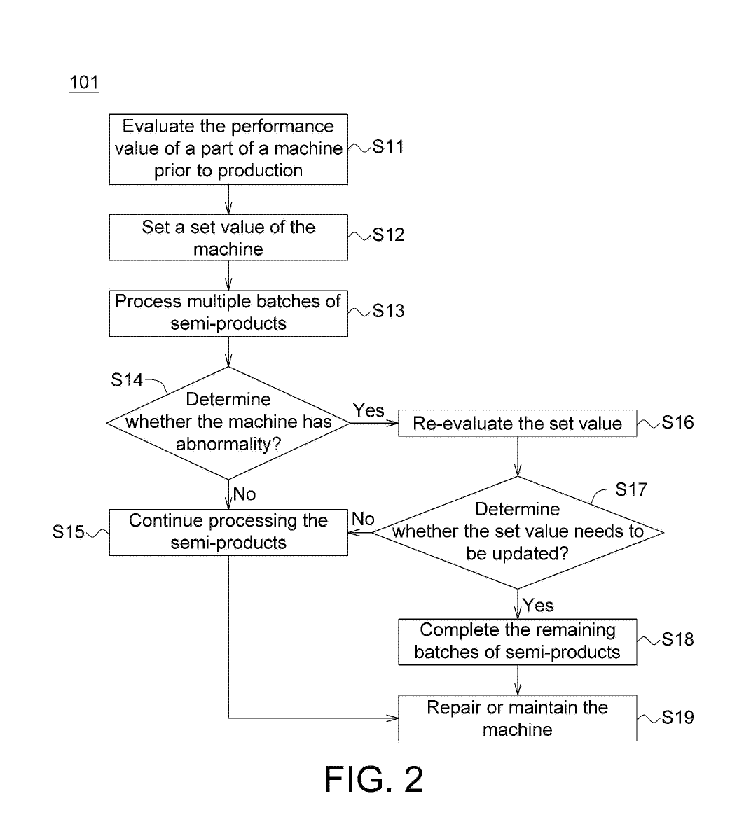

FIG. 1 is a schematic diagram of a machine diagnostic system 100 according to an embodiment of the invention. FIG. 2 is a schematic diagram of a machine diagnostic method 101 according to an embodiment of the invention.

According to an embodiment of the invention, the machine diagnostic system 100 and the diagnostic method 101 are capable of evaluating a performance value of each part 104 prior to production to obtain the remaining lifespan of the part 104 and evaluate whether the part 104 can be used to complete the multiple batches of semi-products within the remaining lifespan according to the set value of the machine 102 to optimally adjust the set value of the machine 102.

According to an embodiment of the invention, the machine diagnostic system 100 and the diagnostic method 101 are capable of detecting the real-time production state of the machine 102 during the production process. When it is detected that the machine 102 is abnormal, the diagnostic system 100 re-evaluates whether the machine 102 can complete the remaining batches of semi-products according to the set value of the machine 102. If yes, the machine 102 continues processing the remaining batches of semi-products. If no, the set value of the machine 102 is updated, so that the machine 102 can complete the remaining batches of semi-products, and the repair schedule of the machine 102 is arranged when the remaining batches of semi-products are completed, so that the downtime repair schedule can be optimally adjusted.

According to an embodiment of the invention, the machine diagnostic system 100 stores multiple predetermined adjustment strategies, historical production data and historical set value of the machine 102. When it is detected that the machine 102is abnormal, the diagnostic system 100 can select an optimal adjustment strategy from the predetermined adjustment strategies. The selected optimal adjustment strategy is, for example, adjusting the parameter data of the part 104 and other parts 104 of the machine 102 and predicting whether the machine 102 can be used to complete the remaining batches of semi-products according to the adjusted parameter data. If yes, the adjusted parameter data is used as the set value and the set value of the machine 102 is updated accordingly.

Besides, when it is detected that the machine 102 is abnormal, the machine diagnostic system 100 can select an optimal adjustment strategy from the predetermined adjustment strategies. The selected optimal adjustment strategy is, for example, keeping the set value and continuing processing the remaining batches of semi-products or complete other batches of unprocessed semi-products.

Moreover, when it is detected that the machine 102is abnormal, an optimal adjustment strategy can be selected from the predetermined adjustment strategies. The selected optimal adjustment strategy, for example, constructing a dynamic learning curve according to the historical production data of the machine 102 and the historical set value of the machine 102, and adjusting the set value of the machine 102 according to the dynamic learning curve so that the current parameter data can be adjusted to be consistent with the historical parameter data and self-learning can be achieved.

Detailed descriptions of the invention are disclosed below with a number of embodiments. However, the disclosed embodiments are for explanatory and exemplary purposes only, not for limiting the scope of protection of the invention. Similar/identical designations are used to indicate similar/identical elements. It should be noted that following embodiments are explained using modular element. The modular element is not limited to the hardware such as a computer or a processor. Instead, the modular element can also be realized by a computer program or an algorithm stored in the computer for executing the same function or procedure, and the invention is not limited thereto.

Refer to FIG. 1. The machine diagnostic system 100 according to an embodiment of the invention includes a performance evaluating module 110, a machine adjusting module 120, multiple sensors 130 and a database140. The performance evaluating module 110 and the machine adjusting module 120 can be combined as one module or executed by a processor 112. The machine 102 has multiple parts 104. The performance evaluating module 110 evaluates the performance value of a part 104 of a machine 102 prior to production. The machine 102 can be realized by a multi-axis machine tool, a lathe, a milling machine, a welding machine, or an automated robotic arm module, for example. The part 104 of the machine 102 can be realized by a motor, a lead screw, a bearing, a gear, a reducer, a component of a robotic arm or a combination thereof. The performance evaluating module 110 not only evaluates the real-time performance state of each part 104 and the collaborative support between the parts 104 but also predicts whether the part 104 can complete multiple batches of semi-products. Besides, the performance evaluating module 110 can obtain a pre-diagnostic data according to the historical production data and the historical set value stored in the database140 to evaluate the remaining lifespan of the part 104 and predict whether the multiple batches of semi-products can be completed according to the current performance value of the part 104.

The pre-diagnostic data is created and optimized using one of the support vector data description (SVDD) algorithm, the learning curve algorithm, Lagrange multipliers, Karush-Kuhn-Tucker condition and the fuzzy logic algorithm. Therefore, the machine diagnostic system 100 can create a pre-diagnostic model using a small amount of production data, and the training time and the model building time of the machine diagnostic system 100 can be reduced.

The pre-diagnostic model can record the performance value of the part 104 and accurately show the performance index and the remaining lifespan of each part 104, and can arrange the repair or replacement schedule of the part 104 of the machine 102 according to the performance value of the part 104, so that the frequency of unexpected breakdown and repair can be reduced. According to the prior art, most repair schedules of the part 104 of the machine 102 are arranged with reference to the recommended repair time and the historical repair record provided by facility suppliers. The pre-diagnostic model of the invention can predict the performance value of the part 104 and predict whether the current performance value of the part 104 can be used to complete multiple batches of semi-products prior to production, so that the repair cost and production loss caused by unexpected breakdowns can be reduced and the production efficiency can be optimized.

In the present embodiment, the machine 102 can complete multiple batches of semi-products according to a set value set by the machine adjusting module 120. The set value can be adjusted according to the historical production data and the process parameters of the machine 102 collected during the production process. The machine adjusting module 120 stores multiple predetermined adjustment strategies. The database140 stores relevant production data regarding the operation of each part 104 and the sensing data recorded by the sensors 130. Examples of the sensing data include the rotation speed, the torque and the temperature of the motor as well as the path of movement and the speed of movement of the machine 102. Although the motor has a fixed lifespan, the motor may need to be repaired or the part 104 may need to be replaced within the lifespan due to the vibration, friction or noises generated over a long period of use. Therefore, when the sensors 130 detect that the machine 102 has an abnormal state (such as the vibration or the noises being too large), the performance evaluating module 110 must re-evaluate the set value of the machine 102 to avoid the machine 102 having unexpected breakdowns and resulting in repairs.

When re-evaluating the set value of the machine 102, the machine adjusting module 120 adjusts the parameter data of the part 104 (such as a motor) and other parts 104 of the machine 102 which may possibly break down, and the performance evaluating module 110 predicts whether the machine 102 can complete the remaining batches of semi-products according to the adjusted parameter. If yes, the adjusted parameter data is used as the set value of the machine 102.

In the present embodiment, one of the predetermined adjustment strategies can be reducing the rotation speed of the motor, dynamically adjusting the path of movement, or reducing the speed of movement of the motor or a combination of at least two of the above methods to resolve the problems such as the motor being too hot, the vibration being too violent or the electric current being too large. For example, the rotation speed of the motor can be reduced by 5%, 10% or 15% to avoid the risk of the electric current being too large. Although a reduction in the rotation speed of the motor may lead to a reduction in the efficiency of the machine 102, the lifespans of the motor and other parts 104 of the machine 102 can be prolonged. Therefore, after the parameter of the motor is adjusted, the machine 102 can complete the remaining batches of semi-products and unexpected breakdown of the machine 102 can be avoided.

Moreover, when the sensors 130 detect that the robotic arm has abnormal vibration or moves too violently, one of the predetermined adjustment strategies can be reducing the speed of movement or changing the path of movement of the robotic arm or a combination of at least two of the above methods to prolong the lifespan or operation times of the robotic arm.

Or, when the sensors 130 detect that the robotic arm has a biased gravity center of rotation and vibrates or has abnormal noises, one of the predetermined adjustment strategies can be changing the drive path of the motor or reducing the rotation speed of the motor or a combination of at least two of the above methods to reduce the abrasion of the bearing of the motor so as to prolong the operation times and the lifespan of the robotic arm. Therefore, after the parameter of the robotic arm is adjusted, the machine 102 can complete the remaining batches of semi-products and avoid unexpected breakdown of the machine 102.

Furthermore, one of the predetermined adjustment strategies can be dynamically adjusting the set value of the machine 102 by constructing a dynamic learning curve according to the historical production data and the historical set value of the machine 102 stored in the database140 and adjusting the set value of the machine 102 according to the dynamic learning curve. The dynamic learning curve can assure that the part 104 is operated under the optimum state and avoid the performance value of the part 104 being degraded.

Moreover, one of the predetermined adjustment strategies can be maintaining the set value of the machine 102, so that the machine 102 can continue processing the remaining batches of semi-products, and the repair schedule of the machine 102 is arranged after the remaining batches of semi-products are completed.

Refer to FIG. 1 and FIG. 2. FIG. 2 is a schematic diagram of a machine diagnostic method 101 according to an embodiment of the invention.

The machine diagnostic method 101 includes steps S11-S19. Firstly, at step Sit the processor 112 evaluates the performance value of a part 104 of a machine 102 prior to production and predicts whether the part 104 can be used to complete multiple batches of semi-products. In step S12, when it is determined that the part 104 can be used to complete multiple batches of semi-products, the processor 112 sets a set value of the machine 102 to enable the machine 102 to complete the multiple batches of semi-products.

In step S13, the processor 112 enables the machine 102 to process multiple batches of semi-products to generate a real-time production data. In step S14, whether the machine 102 has abnormality is determined. If it is determined that the machine 102 does not have abnormality, then the method proceeds to step S15, the machine 102 continues processing the semi-products until all semi-products are completed, and periodic repair or maintenance of the machine 102 can be arranged. On the contrary, if it is detected that the real-time production data contains an abnormal state data, the method proceeds to step S16, whether the machine 102 can complete the remaining batches of semi-products according to the set value is re-evaluated.

Then, in step S17, whether the set value needs to be updated is determined. If it is determined that the set value does not need to be updated, then the method proceeds to step S15, the machine 102 continues processing the remaining batches of semi-products according to the set value. On the contrary, if the set value needs to be updated, the method proceeds to step S18, the machine 102 continues processing the remaining batches of semi-products according to the updated set value or completes other batches of unprocessed semi-products.

Then, the method proceeds to step S19, the repair or maintenance schedule of the machine 102 is arranged after the remaining semi-products are completed.

When the robot or the machine breaks down, the production line may be suspended over a long period of time and the business will suffer a severe loss. Therefore, whether the robot or the machine has abnormity needs to be accurately diagnosed prior to production without interrupting the production line. The machine diagnostic system of the invention aims to increasing the accuracy of prediction and the efficiency of detection and resolving the said problems of the same kind.

The machine diagnostic system of the invention is mainly used in the monitoring of chemical process, the human-machine collaborating procedure, the grasping procedure, the automotive operation procedure, the debugging/correction procedure, the assembly operation procedure, the sensing/control procedure, the handling operation procedure, the electronic component assembly procedure, the machining operation procedure and so on.

As the next generation of electronic semi-products is directed towards miniaturization and high precision, it becomes more and more difficult to handle the assembly procedure of electronic parts using human labor. Instead, the need for manufacturing electronic semi-products through robot production is increasing. In response to the arrival of industry 4.0, the machine diagnostic system of the invention can effectively avoid unexpected shutdown over a long period of use and can detect the deterioration in the early stage, and therefore will be a focus of design to machinery manufacturers.

While the invention has been described by way of example and in terms of the preferred embodiment(s), it is to be understood that the invention is not limited thereto. On the contrary, it is intended to cover various modification and similar arrangements and procedures, and the scope of the appended claims therefore should be accorded the broadest interpretation so as to encompass all such modification and similar arrangements and procedures.

What is claimed is:

1. A machine diagnostic method, comprising:
evaluating, by a processor, a performance value of a part of a machine prior to production;
predicting, by the processor, whether the part can be used to complete a plurality of batches of semi-products;
in response to predicting that the part can be used to complete the plurality of batches of semi-products, setting, by the processor, a set value of the machine to enable the machine to complete the plurality of batches of semi-products;
enabling, by the processor, the machine to process the plurality of batches of semi-products to generate a real-time production data;
in response to detecting that the real-time production data contains an abnormal state data, re-evaluating, by the processor, whether the set value of the machine enables the machine to complete remaining batches of semi-products;
in response to re-evaluating that the set value of the machine enables the machine to complete the remaining batches of semi-products, enabling, by the processor, the machine to continue processing the remaining batches of semi-products according to the set value; and
in response to re-evaluating that the set value of the machine does not enable the machine to complete the remaining batches of semi-products, updating, by the processor, the set value of the machine to enable the machine to complete the remaining batches of semi-products.

2. The machine diagnostic method for machine according to claim 1, wherein updating the set value of the machine refers to adjusting parameter data of the part and other parts of the machine and predicting whether the machine can complete the remaining batches of semi-products according to the adjusted parameter data; and in response to that the adjusted parameter data enables the machine to complete the remaining batches of semi-products, the adjusted parameter data is used as the set value.

3. The machine diagnostic method for machine according to claim 1, further comprises storing a plurality of predetermined adjustment strategies, and updating the set value of the machine refers to adjusting parameter data of the part and other parts of the machine according to one of the predetermined adjustment strategies and predicting whether the machine can complete the remaining batches of semi-products according to the adjusted parameter data; and in response to that the adjusted parameter data enables the machine to complete the remaining batches of semi-products, the adjusted parameter data is used as the set value.

4. The machine diagnostic method for machine according to claim 3, wherein one of the predetermined adjustment strategies refers to enabling the machine to continue processing the remaining batches of semi-products or other batches of unprocessed semi-products.

5. The machine diagnostic method for machine according to claim 3, wherein one of the predetermined adjustment strategies comprises dynamically adjusting the set value of the machine to avoid the performance value of the part being degraded.

6. The machine diagnostic method for machine according to claim 3, wherein one of the predetermined adjustment strategies comprises constructing a dynamic learning curve according to historical production data and historical set values of the machine and adjusting the set value of the machine according to the dynamic learning curve.

7. The machine diagnostic method for machine according to claim 1, wherein the performance value of the part is generated and data optimized according to historical production data of the machine using one of support vector data description (SVDD) algorithm, learning curve algorithm, Lagrange multipliers, Karush-Kuhn-Tucker condition and fuzzy logic algorithm.

8. A machine diagnostic system, comprising:
a processor comprising a performance evaluating module and a machine adjusting module, wherein
the performance evaluating module is for evaluating a performance value of a part of a machine prior to production and predicting whether the part can be used to complete a plurality batches of semi-products;
in response to predicting that the part can be used to complete the plurality of batches of semi-products, the machine adjusting module sets a set value of the machine to enable the machine to complete the plurality batches of semi-products; and
a plurality of sensors for sensing the machine processing the plurality of batches of semi-products to generate a real-time production data, wherein
in response to detecting that the real-time production data contains an abnormal state data, the performance evaluating module re-evaluates whether the set value of the machine enables the machine to complete remaining batches of semi-products;
in response to re-evaluating that the set value of the machine enables the machine to complete the remaining batches of semi-products, the machine adjusting module enables the machine to continue processing the remaining batches of semi-products according to the set value; and
in response to re-evaluating that the set value of the machine does not enable the machine to complete the remaining batches of semi-products, the machine adjusting module updates the set value of the machine to complete the remaining batches of semi-products.

9. The machine diagnostic system according to claim 8, wherein updating the set value of the machine refers to adjusting parameter data of the part and other parts of the machine and predicting whether the machine can complete the remaining batches of semi-products according to the adjusted parameter data; and in response to that the adjusted parameter data enables the machine to complete the remaining batches of semi-products, the adjusted parameter data is used as the set value.

10. The machine diagnostic system according to claim 8, wherein the machine adjusting module stores a plurality of predetermined adjustment strategies and updating the set value of the machine refers to adjusting parameter data of the part and other parts of the machine according to one of the predetermined adjustment strategies and predicting whether the machine can complete the remaining batches of semi-products according to the adjusted parameter data; and in response to that the adjusted parameter data enables the machine to complete the remaining batches of semi-products, the adjusted parameter data is used as the set value.

11. The machine diagnostic system according to claim 10, wherein one of the predetermined adjustment strategies refers to enabling the machine to continue processing the remaining batches of semi-products or other batches of unprocessed semi-products.

12. The machine diagnostic system according to claim 10, wherein one of the predetermined adjustment strategies comprises dynamically adjusting a set value of the machine to avoid the performance value of the part being degraded.

13. The machine diagnostic system according to claim 10, wherein one of the predetermined adjustment strategies comprises constructing a dynamic learning curve according to historical production data and historical set values of the machine and adjusting the set value of the machine according to the dynamic learning curve.

14. The machine diagnostic system according to claim 8, wherein the performance value of the part is generated and data optimized according to the historical production data of the machine using one of support vector data description (SVDD) algorithm, learning curve algorithm, Lagrange multipliers, Karush-Kuhn-Tucker condition and fuzzy logic algorithm.
